(19) United States
(12) Patent Application Publication
(10) Pub. No.: US 2008/0195675 A1
(43) Pub. Date: Aug. 14, 2008

(54) Method for Pertorming Distributed Backup on Client Workstations in a Computer Network

(76) Inventors: Yann Torrent, Paris (FR); Faycal Daira, Paris (FR)

Correspondence Address: BLANK ROME LLP, 600 NEW HAMPSHIRE AVENUE, N.W., WASHINGTON, DC, 20037, US

(21) Appl. No.: 11/632,281

(22) PCT Filed: Jul. 12, 2005
(86) PCT No.: PCT/FR2005/050572

§ 371 Date: Jan. 2, 2008

(30) Foreign Application Priority Data
Jul. 15, 2004 (FR) 04/51534

(51) Int. Cl. G06F 17/30

(52) U.S. Cl. 707/204; 707/E17.007

(57) ABSTRACT

The invention concerns the field of computers and the saving of digital data. The invention concerns a method for saving digital data on a multiple machines connected to a computer network. The invention is characterized in that it does not employ a centralized computer server, and in that it comprises the following steps: first calculating and transmitting the load of machines to other machines of the network, said step being performed by the machines themselves; distributed saving of said data, the selection and the distribution of data being performed by said machines, so that the loads concerning the data are distributed in automated fashion and achieve a balanced load of the machines.

The present invention relates to the field of computing and to backing up digital data.

The present invention relates more particularly to a method for backing up digital data in distributed manner on a set of client workstations of a computer network.

While the global volume of data has doubled over the last three years, the rate of use of the storage resources of most networks is estimated to be 30%. In particular, client workstations are little used for storing digital data for the benefit of servers, whose reliability and uptime (mean time of operation between two restarts of the machine, illustrating the stability of the machine) must be high. Since they are very numerous and have unused resources, client workstations represent high data storage capacities making it possible to offer high redundancy for the backed-up information.

In the prior art, there is already disclosed, by US Patent Document U.S. Pat. No. 6,430,611 (Jefferson A. Kita et al.), a storage management system for managing storage resources of a plurality of computer devices in a computer network. That system includes a plurality of management agents, each of which is installed in a corresponding one of said computer devices, and each of which is configured to compile storage information of storage resources accessible by the corresponding computer device to create a first set of compiled storage information, and a storage manager installed in the server. The storage manager is configured to collect the first set of compiled storage information from each of the management agents and to further compile the first sets of storage information received to create a second set of compiled storage information. The storage management system further includes a user interface operatively coupled to the server manager to allow a user to access the second set of compiled storage information.

That solution is limited because it requires the use of a server and does not describe automation of the distribution of the data.

There is also disclosed, by US Patent Document U.S. Pat. No. 6,728,751 (Robert Thomas Cato et al.) a system for backing up digital data on client machines. Within a network of computers, a system administrator function controls the backing up of data of client machines to select other client machines within the network by removing control of and access to portions of the hard files within those machines from the local user. The freed-up storage space within the client's local hard files is then used for backup purposes to back up data from other machines within the network. Agents in the server and client machines perform this task making it possible to distribute the backup workload across the network. There are three modes of backup: source initiated, target initiated, and server communal backup (CB) agent initiated. All are coordinated by the server CB agent. That solution also implements a server. The system thus depends heavily on the reliability of the server. In addition, major costs are incurred for maintaining the server viable and/or for proposing redundancy for that server.

There is also disclosed, by US Patent Application Document US 2004/0 049 700 (Takeo Yoshida), an inexpensive data storage method utilizing available capacity in individual computer devices connected to a network. When a backup client of a user personal computer (PC) receives a backup instruction for backing up a file from a user, the backup client requests backup to a backup control server. The backup control server divides and encrypts the file to be backed up into a plurality of encrypted pieces, transfers the encrypted pieces to user personal computers (PCs), and stores the encrypted pieces in the hard disk drives (HDDs) of the user PCs. When the distributively backed-up file is to be extracted, the user PC obtains each of the encrypted pieces from the user PCs in which they are stored, and combines and decrypts the encrypted pieces to restore the original file.

That solution is based on considerable centralization of the operations on a server. This therefore implies a high level of dependency relative to said server and relatively high operating costs in order to maintain the server.

There are also disclosed, in the state of the art, automated methods of backing up digital data on servers. Those methods are performed on network architecture or on client workstations, and one or more servers are connected to a computer network. Agents situated on the various client workstations establish, at a fixed time, a list of files modified since the last backup, and then they transfer that data to the backup servers. Those methods are commonly used in firms for backing up the data of employees. Nevertheless, those mechanisms do not make it possible to take advantage of the numerous unused resources of the client workstations.

An object of the present invention is to remedy the drawbacks of the prior art by providing a method for performing distributed backup over a computer network.

The method for the present invention accommodates budget restrictions of firms particularly well because it makes it possible to take advantage of the resources in terms of storage capacity and of processing capacity that are not used by the client workstations.

In addition, in the chosen architecture, the absence of a dedicated server makes it possible to overcome the problems of reliability suffered by such machines. Whereas existing methods show heavy dependency on machines (servers, among others), the invention makes it possible to overcome that dependency: all of the client workstations take part in the distributed backup, with the backup being redundant on a plurality of workstations.

To this end, the invention, in its most general acceptation, provides a method for backing up digital data on a plurality of items of computer equipment connected to a computer network, said method being characterized in that:

it does not implement any centralized computer server;

it comprises:
a prior step of calculating the workloads of the items of equipment and of transmitting said workloads to the other items of equipment of the network, this step being performed by the items of equipment themselves; and
a distributed backup step of backing up said data in distributed manner, the selection and the distribution of the data being performed, by said items of equipment, so that the workloads relating to the data are distributed automatically and an in such a manner as to achieve a balance of the workload of the items of equipment.

Preferably, said workloads of the items of equipment depend on the CPU, RAM, hard disk, and uptime resources.

Advantageously, said backup step comprises a sub-step of subdividing said data into blocks.

In a particular implementation, said blocks are encrypted.

Preferably, said backup step is performed using RAID 5 technology.

In an implementation, said method further comprises a step of versioning said backed-up data.

Preferably, said method further comprises a step of determining the profile of the user and a step of deleting the old versions of said data that do not correspond to said determined profile.

In a variant, said backing up is distributed over the items of equipment of a sub-group of said network.

The present invention also provides a system for backing up digital data in distributed manner, which system comprises a plurality of items of computer equipment, at least one computer network to which said items of computer equipment are connected for implementing the method.

The invention can be better understood from the following description of an implementation of the invention, given merely by way of explanation and with reference to the accompanying figures, in which:

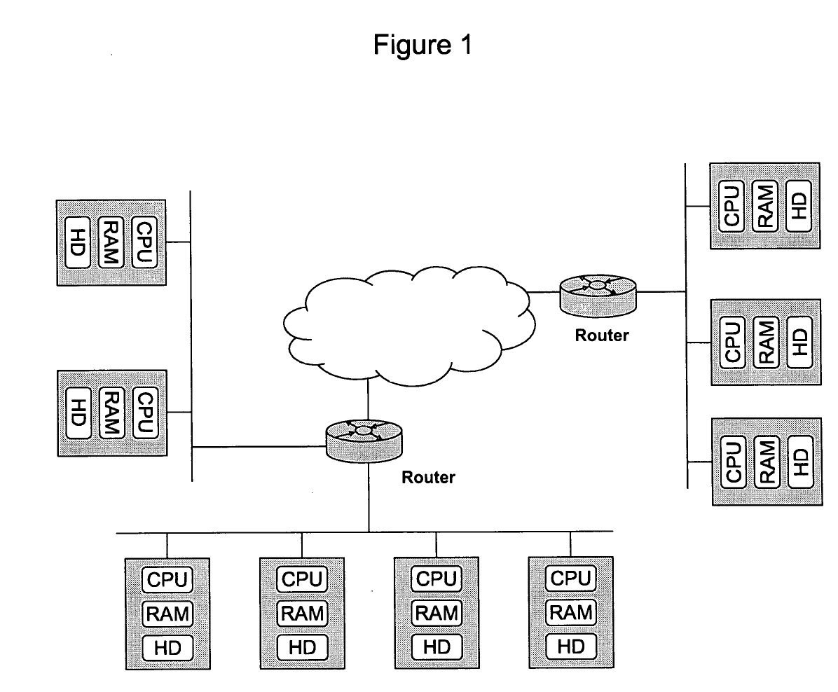

FIG. 1 shows the overall architecture of the system;

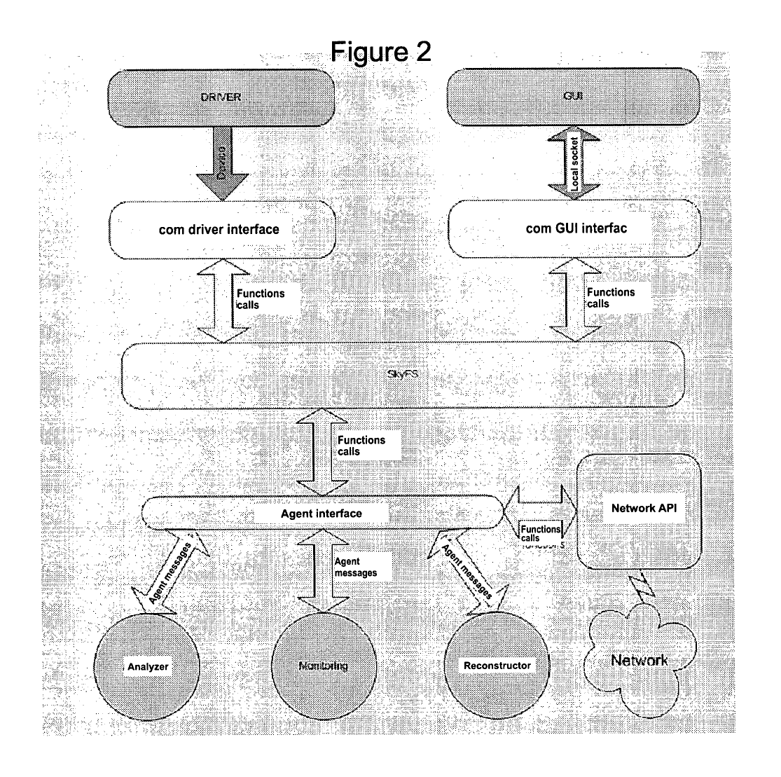

FIG. 2 shows the overall architecture of a client system;

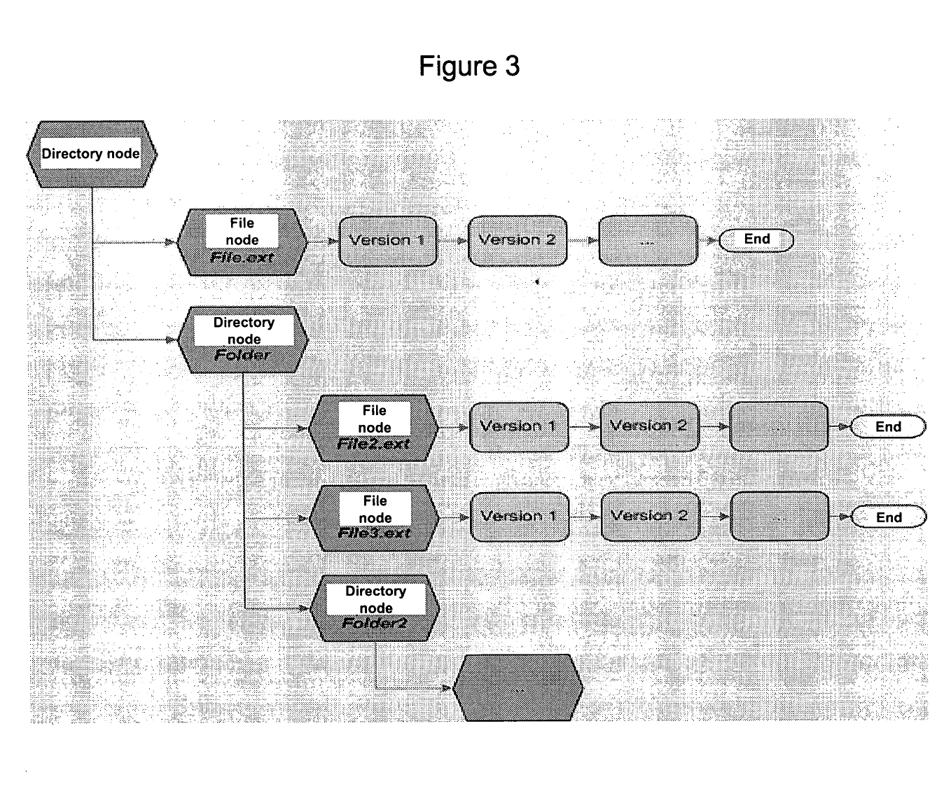

FIG. 3 shows how the system of virtual files is organized;

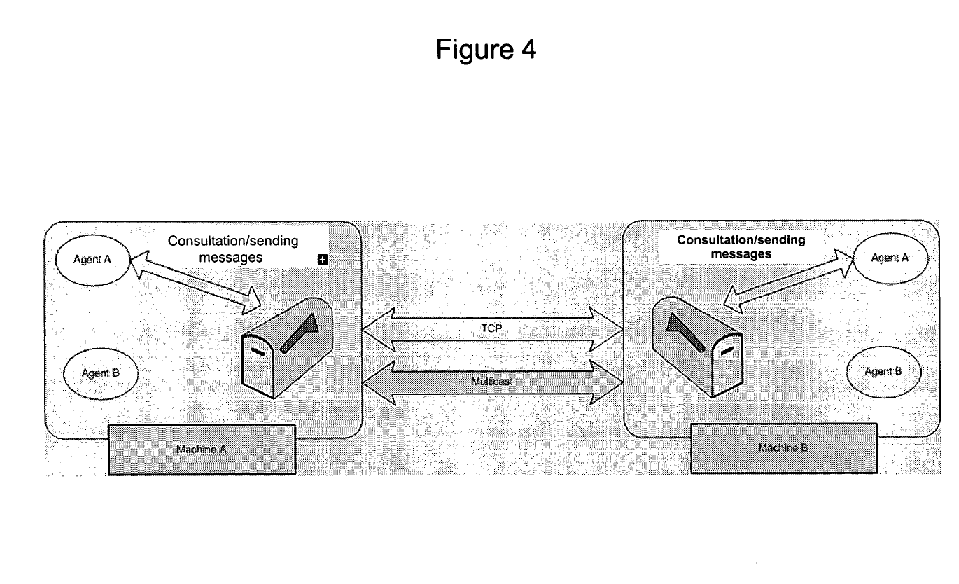

FIG. 4 shows the various communications channels of the system;

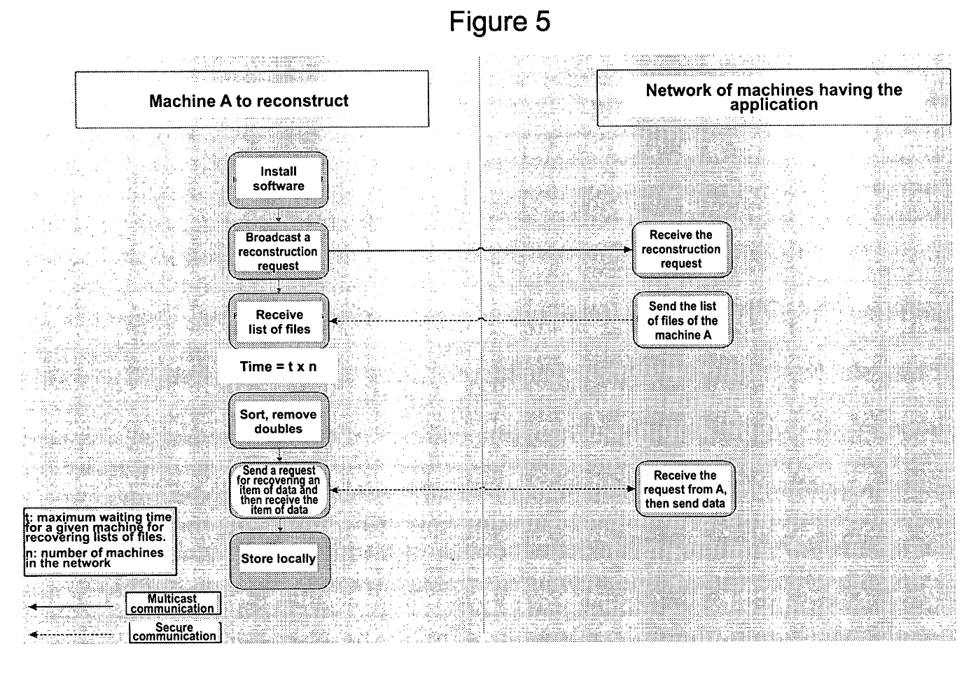

FIG. 5 shows an interchange of messages after an item of equipment crashes; and

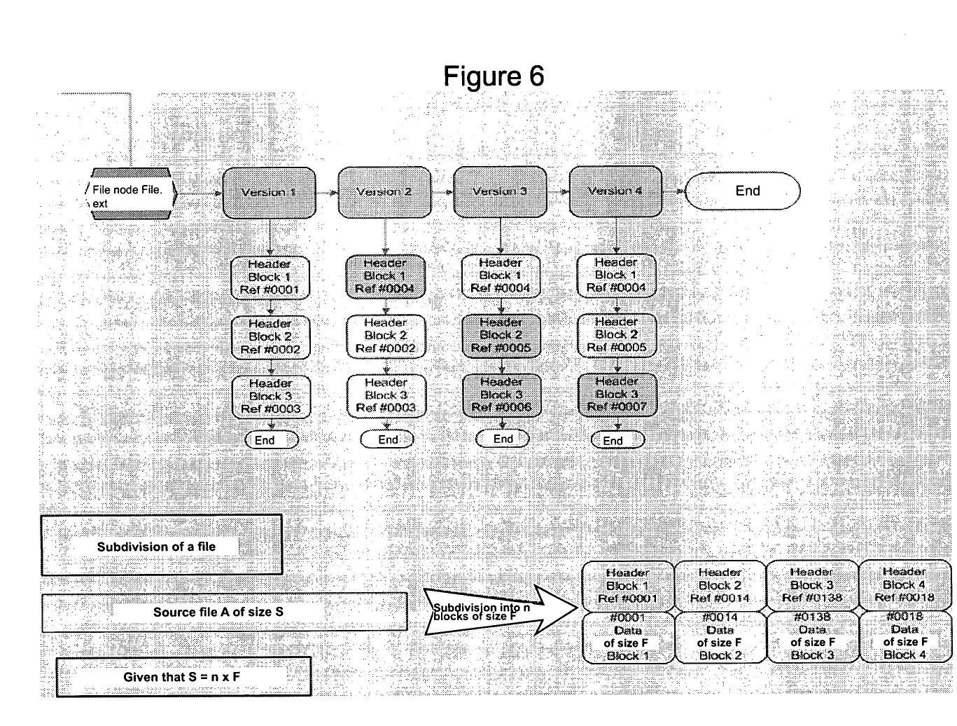

FIG. 6 shows the versioning mechanism.

The present invention implements a method for backing up digital data in distributed manner over a computer network.

The invention operates on an entire fleet of computers, and it does not need a dedicated server, or a network administrator. The system of files uses all of the unused free space of all of the machines connected to the computer fleet. The program decides to protect, to back up and to send data over the network, which data is encrypted and stored on other machines.

The objective of the invention is to put in place a backup solution integrated into the operating system without using additional and specific computer hardware or technical skills. This solution is achieved in total transparence with the system because it implements low-level modules, in particular via a kernel driver that is integrated easily into the operating system.

The project is built around an IA (Independent Agent) technology based on independent agents that distribute and reconstruct the data properly.

The various advantages of the method for the present invention relate to:
distribution over all of the machines in the network;
management of a mechanism for versioning the backed-up files;
absence of a server;
multi-platform compatibility;
high redundancy; and
increased transparence to the system by the use of a kernel driver.

With reference to FIG. 1, the system of the present invention comprises a computer network to which workstations of the computer type are interconnected. All types of network lie within the ambit of the invention, from wired computer networks (Local Area Networks (LANs), and the Internet) to wireless networks (WiFi networks).

Each computer workstation has processor resources (Central Processing Unit (CPU)), Random Access Memory (RAM) resources, and storage resources (Hard Disks (HDs)).

An object of the invention is to provide a solution for storing data that can use all of the storage resources (HDs) of the computer workstations. For this purpose, the following constraints are set:
information transfer must fully satisfy the real-time constraints of the network such as availability of all of the connected computers;
data extraction and reconstruction must be as fast as possible for all of the users; and
a restoration message must be sent to the network following a machine crash, thereby guaranteeing optimum security for data restoration.

For this purpose, the solution adopted and present in each machine is modular with a kernel which, by its low level, optimizes the access time to the resources of the system, and a daemon and modules at a higher level (user level) performing interfacing with the kernel and with the various resources of the equipment (network, memory, user interface).

These various portions can be developed in a computer environment in the C language making low-level interaction possible.

The kernel hooks the various disk accesses (read, write, open, close, rename, delete, stat, statfs, readdir) to specific functions. These accesses are then redirected via a device to the UserLand process, and are interpreted by the various agents of the program.

The kernel represents the Virtual File System (VFS) which makes it fully integrated into the operating system (transparent for the user). The backup folder can, for example, be C:/My Documents/ but a virtual representation of the backup file can also be made by using a virtual reader, e.g. J:/.

All of the functionality features of storage, and of resolution of file names of the system of files are executed in the UserLand process, and the kernel serves merely as an interface with the system of files.

A communications module is coded in parallel with the kernel, and its purpose is to recover the messages coming from the kernel and to send them to the storage modules and to the analyzer agent, etc.

In the overall architecture, the user space is made up:
of a communications interface whose purpose is to check that the data is transmitted between the kernel and the user interface and to provide connectivity with the other modules, and in particular that the requests are performed correctly and return the expected values;
of a Graphical User Interface (GUI) module;
of a local storage module that performs local storage of the files and management of the versions and of the reconstruction of files on the basis of the pieces recovered; and
of a distribution system whose roles are to dispatch, distribute, and reconstruct the data in secure manner over the network.

With reference to FIGS. 2 and 3, the core of the system is made up of a Virtual File System (VFS). This module represents the core of the system of files, and it has the task of organizing the vnodes (single structure representing all of the information of a resource such as a file or a directory), the inodes (structure stored in each vnode containing the system information of the file such as the date of creation, the type, the size, etc.).

Each vnode represents a node of a tree having “n” branches. On each vnode, there is the offset of the first block of the associated data (only if it is a file). The data blocks are stored at another place, independently of the tree of the system of files.

This module manages, in parallel, the remote storages that are stored in a place independently of the local storage.

The local storage corresponds to the storage of the user of the current machine. This storage takes account of the problems of versions of the files. It acts as cache because it has all of the data of the current user.

The remote storage has only the information and the data of the remote users. The two storages are not associated so that each user can keep their own environment so as to guarantee improved security.

The local storage, and its Virtual File Allocation Table or “vfat” (system tree+data blocks) are not encrypted, and only the remote storage is encrypted because it is unnecessary to encrypt data that is already accessible unencrypted at the mounting point (vfat), and only the “remote” data is sensitive because it does not belong to the user of the local machine.

Also with reference to FIG. 2, the agents perform the functionality features of the present invention.

The monitoring agent is a very important agent because it has a dual role:
it assesses the reliability of its host machine, its usable free space, and the quality of the passband; with all of these criteria, it broadcasts a weight which summarizes the “quality” of the machine. These weights are very important because they make it possible, at the time of distribution of an item of data, to elect those machines which are potentially advantages in the network at a given time; and
the second role of the monitoring agent is to keep the list of machines connected to the network up to date in real time.

This module also elects the pool of machines that are chosen for deploying a resource. When the weight changes significantly (+ or −), the weight is broadcast again over the network so that all of the machines update. When the machine stops, a stop frame is sent, or indeed, if a machine can no longer make contact with another machine, it then informs the other machines that the machine in question is no longer connected.

The reconstructor agent is used only after a machine crash, the role of this agent being to retrieve and to reconstruct as quickly as possible the vfat and then the data blocks over the entire computer fleet.

It uses multicast messages to inform all of the other machines at the same time, and the reconstructor agent of each remote machine satisfies the request on a case-by-case basis.

The analyzer agent is crucial because it decides whether or not it is pertinent to create a new version of a resource in the system of files, and/or to send said resource to the various machines in order to perform one or more remote backups. This agent is independent and, in order to make its choice, takes into consideration a plurality of important system criteria, in particular the size of the resource, its date of updating etc. (this list is not limiting to the usable parameters).

FIG. 4 shows the various communications channels of the system. A communications module centralizes the sending of messages from each of the agents and sends them either to the destination agent (agent B) or to the destination network of another machine (machine B).

In one embodiment, when a machine connects up to the network, the monitoring agent broadcasts information illustrating the availability of the machine. Said information can, for example, contain the Internet Protocol (IP) address that identifies the machine uniquely and a coefficient characteristic of the availabilities of the resources of the machine. The coefficient or weight can be a function of the CPU, RAM, HDD, and uptime information.

This information can be sent by multicasting when the network is structured into subgroups. In addition, this sending is repeated during operation of the machine, e.g. after an allotted time, or when its coefficient has been modified.

The agents of each of the machines of the network of the sub-group thus have the list of the (IP, coefficient) of each of the other machines. For security reasons, the list is validated by a Transmission Control Protocol (TCP) connection to each of the machines, and by sending a Secure Sockets Layer (SSL) certificate, e.g. SSLv3+X509 v3 Certificates.

On editing or creating a file, the agents perform a double backup of the file.

Firstly, a local backup is performed that is preferably non-encrypted even though certain systems of files automatically encrypt the data.

Secondly, the file is subdivided into pieces that are either of fixed size (e.g. 1024 bytes) or of size adapted as a function of the type of file (multimedia) or of its own size. A header (name of the file to which it belongs, number of block, etc.) is added to the piece and the resulting set is encrypted using a conventional encryption algorithm. For example:
method: keys derived from the passphrase: PKCS#5 v2 (PBKDF2-HMAC-SH1);
data encryption: AES 128 bits; and
random number generator: Bob Jenkins's ISAAC (Indirection, Shift, Accumulate, Add, and Count)

The most sensitive portion is generating the keys serving to encrypt the data and the metadata: it is necessary to avoid collision of generated keys while also keeping sight of increased performance. For this purpose it is necessary to benchmark the encryption system so as to reduce the security if the performance is poor. A change of passphrase leads to deletion of the previous data, except if the locally backed-up data is re-encrypted and if they are redistributed during the night or when the machine is not used.

The blocks encrypted in this way are sent in secure manner to various machines in order to provide redundancy for the backup. The number of machines to which the blocks are sent is defined by the administrator of the system. This distribution of the data over various different machines makes it possible, where necessary, to have a plurality of ways of recovering the data: if one computer crashes, the data is still available on another workstation. It is this distribution that gives the name “distributed backup”.

The agents of the machines in question receive the blocks and store them locally.

In order to optimize the performance of the solution, the agents make use of the “slack” periods of the machines in order to perform all sorts of actions: de-fragmentation of the data blocks, cleaning the workstation of the oldest blocks in order to recover memory space, etc.

In another implementation, a machine belonging to a network has crashed, and all of the data has been lost.

With reference to FIG. 5, after reinstallation of the agents, the machine sends a multicast request including an identifier of the machine (IP address, Dynamic Host Configuration Protocol (DHCP) name of the machine, etc.) or a request on the machines that are the most available.

The machines indicate the data (blocks) of the crashed machine that they have. The crashed machine then makes a specific request for the data to the most available machines so as to recover all of the initial data as quickly as possible.

After receiving the blocks, the agents reconstruct the original files.

As shown in FIG. 6, a versions archiving system is implemented in the solution of the present invention.

This versioning solution makes it possible, inter alia, to recover old versions of a file. For this purpose, each time a file is modified, backup with a version increment is performed only on those data blocks which have been modified or on those which have been created. The version 2 of the file.ext file differs from the version 1 by a new block 1 (Ref #0004). As regards the version 4, it is made up of the block 1 (Ref #0004) modified for the version 2, of the block 2 (Ref #0005) modified for the version 3 and of the block 3 (Ref #0007) modified for the version 4.

This solution of differential versioning makes it possible to achieve a considerable saving in space compared with solutions that back up the entire file for each version.

Archiving of the versions can be based on a number given to each version or, more simply, on the use of the data for hierarchizing the blocks.

In order to increase the effectiveness of the system, learning mechanisms or behavior analysis mechanisms are also put in place in order to establish user profiles: for example, the more regularly a file is accessed, the more the versioning must be frequent, the documents with .doc and .xls extensions are regularly backed up in different versions for a user of the “secretarial” type, and source codes for a computer specialist are also backed up very regularly.

In addition, static rules can be established by the administrator, which rules determine the versioning policy.

In an implementation, the redundancy of the data is achieved by the RAID 5 technique (RAID: Redundant Array of Inexpensive Disks) consisting in establishing parity of at least two elementary data blocks. By taking two blocks coming from the fragmentation of one memory page, a “parity” third block is constructed so that the third block associated with either one of the first or second blocks makes it possible to retrieve the unused block.

The strength of such a mechanism lies in the fact that not all of the parity blocks are data items that can be used by themselves. Thus, the operation of encrypting the data is necessary only on the blocks of “pure data”. N data blocks can be retrieved from a single block of pure data and from (N−1) parity blocks.

The invention is described above by way of example. It is understood that the person skilled in the art is capable of implementing various variants of the invention without going beyond the ambit of the patent.

1. A method for backing up digital data on a plurality of items of computer equipment (1), each of which includes a monitoring module (10), which items of equipment are connected to at least one computer network (2), said method being characterized in that it comprises:
a prior step performed by each of the monitoring modules (10) of said items of equipment (1), which step consists in calculating a workload representative of the availability of the resources of the item of equipment, and in transmitting said workload to the other items of equipment of the network; and
a distributed backup step of backing up said data of an item of equipment in distributed manner, which step comprises:
a step of selecting a set of said items of equipment, which step is performed by said monitoring module (10) of the item of equipment, as a function of said workloads of the items of equipment; and
a step of securely transmitting the data to said set of the items of equipment.

2. A method for backing up digital data according to the preceding claim, characterized in that said workloads of the items of equipment depend on the CPU, RAM, hard disk, and uptime resources.

3. A method for backing up digital data according to the preceding claims, characterized in that said backup step comprises a sub-step of subdividing said data into blocks.

4. A method for backing up digital data according to the preceding claim, characterized in that said backup step further comprises a step of encrypting said blocks, which blocks are transmitted encrypted during the secure transmission step.

5. A method for backing up digital data according to claim 3, characterized in that said backup step is performed using RAID 5 technology.

6. A method for backing up digital data according to the preceding claims, characterized in that it further comprises a step of versioning said backed-up data.

7. A method for backing up digital data according to the preceding claim, characterized in that it further comprises a step of determining the profile of the user and a step of deleting the old versions of said data that do not correspond to said determined profile.

8. A method for backing up digital data according to the preceding claims, characterized in that said backing up is distributed over the items of equipment of a sub-group of said network.

9. A system for backing up digital data in distributed manner, which system comprises a plurality of items of computer equipment, at least one computer network to which said items of computer equipment are connected for implementing the method according to any preceding claim.
